(19) United States
(12) Patent Application Publication
(10) Pub. No.: US 2004/0155599 A1
(43) Pub. Date: Aug. 12, 2004

(54) Electronic ballast for HO fluorescent lamps

(76) Inventor: Carlos Gabriel Bianchim, Curitiba (BR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/706,281

(22) Filed: Nov. 13, 2003

(30) Foreign Application Priority Data
Nov. 13, 2002 (BR) PI 0205859-6

(51) Int. Cl. H05B 37/02

(52) U.S. Cl. 315/247; 315/312; 315/291

(57) ABSTRACT

“ELECTRONIC BALLAST FOR HO FLUORESCENT LAMPS”, the present patent is described as an electronic ballast which, in accordance with the characteristics thereof, possesses as a principle the formation of an electronic piece of equipment intended for the control of HO fluorescent lamps (A) incorporating a proprietary structure and containing a properly customized, integrated and complete electronic circuit (1), arranged in a casing as a protection element of the assembly in internal and external environments, being formed by a power factor rectification and control block (2), a half-bridge block (3) and an ignition pulse block (4), in order to make available a device for control and activation of HO fluorescent lamps (A) capable of being operated in any environment and with the purpose of controlling from one to six lamps, flexible to the installation needs, depending exclusively on the sum of power of the HO fluorescent lamps (A), which cannot exceed three hundred and ninety watts.

The present patent relates to electronic pieces of equipment in general, more specifically to an electronic ballast for HO fluorescent lamps, which, according to the characteristics thereof, possesses as a basic principle the formation of an electronic piece of equipment intended for the control of HO fluorescent lamps (long size) in distribution power from ninety to two hundred and fifty Volts, in order to be used to control from one to six lamps, flexible to the installation needs, being based on a robust, safe and versatile electronic ballast. With specific design and shape, easily accessible for a better adaptation and safety for the users, practical handling and functionality, accessible cost and, due to its characteristics and dimensions, is easily adaptable to any type of HO fluorescent lamp commonly used in billboards, parking lots and patios in general, regardless of the general characteristics thereof.

The patent in question is characterized in that it aggregates components and processes in a differentiated concept to meet the various requirements the nature of its use demands, i.e., the electronic control of HO fluorescent lamps. Such concept provides the electronic ballast great efficiency, functionality, strength, safety and versatility due to its excellent technical qualities, therby providing advantages and improvements to the process as a whole, the general characteristics of which differ from the other shapes and models known in the current state of the art.

The present patent consists in the utilization of a practical, modern, efficient and accurate electronic ballast for HO fluorescent lamps, formed by an assembly of properly incorporated electrical and electronic solutions comprising a complete and differentiated electronic ballast, with exclusive design, optimum finish details and proprietary characteristics, incorporating a proprietary structure of high durability and strength, and containing a properly customized, integrated and complete electronic circuit, arranged in a caging as protection element of the assembly in internal and external environments, and which operates in distributing power from ninety to two hundred and fifty Volts, being formed by a power factor rectification and control block as an element to obtain unit power factor and noise reduction, a half-bridge block as a high-frequency power supply and protection element and an ignition pulse block as a power supply element for the lamp activation, so as to make available a device for control and activation of HO fluorescent lamps capable of being operated in any environment and with the specific purpose of controlling from one to six lamps, flexible to the installation needs, depending on exclusively on the sum of power of the lamps, which cannot exceed three hundred and ninety watts.

The patent in question aggregates components and processes in a concept which differs from the other shapes and models known in the current state of the art intended for the control of HO fluorescent lamps (long size), thereby allowing to solve some of the main inconveniences of the other electromagnetic and/or electronic ballasts for HO fluorescent lamps, which are located in a work range wherein there is no protection system for the absence of load, for high power factor and for high output; a system that allows a variation in the total amount of HO fluorescent lamps without the need of change in the electronic circuit; and a system that meets the electromagnetic interference standars (CISPR 15), making it impossible to be used in environments where the generation of electromagnetic noises is not allowed, and which directly generates the assembly of a low performance and efficiency and, mainly, a low general versatility.

The objects, advantages and other important characteristics of the patent in question can be more easily understood when read jointly with the appended drawings, wherein:

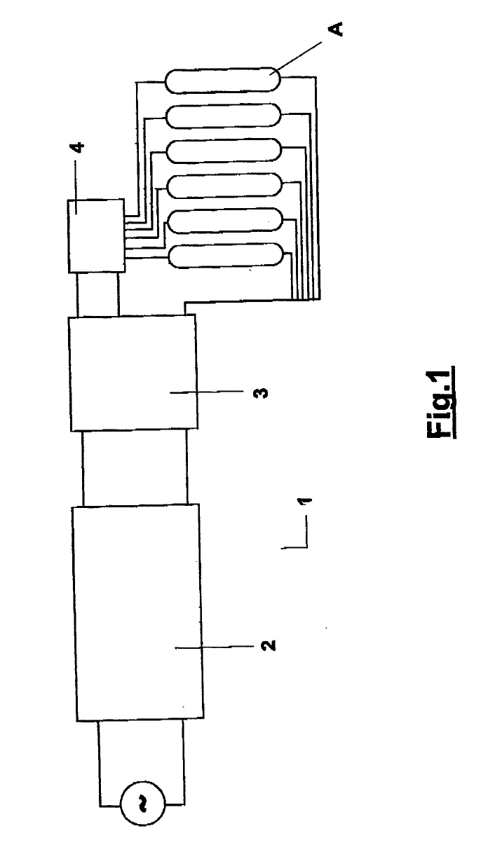

FIG. 1 is a diagram of blocks of the electronic circuit for the electronic ballast for HO fluorescent lamps.

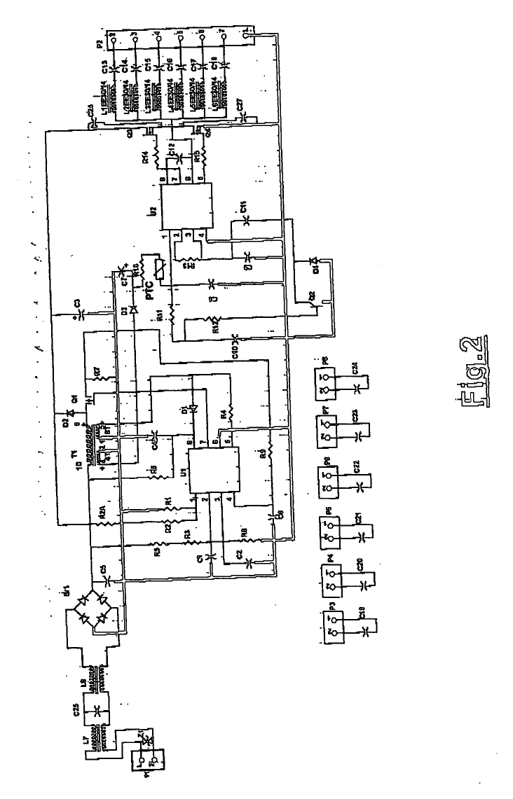

FIG. 2 is the electrical diagram of the electronic circuit for the electronic ballast for HO fluorescent lamps.

As can be inferred from the appended drawings that illustrate and integrate the present descriptive report of the patent of invention of “Electronic Ballast for HO Fluorescent lamps”, FIG. (1) shoes the same in a general manner, comprising a complete and differentiated electronic ballast for control and activation of HO fluorescent lamps (A), capable of being operated in any environment and incorporating a proprietary structure of high durability and strength, and containing a properly customized and integrated electronic circuit (1), arranged in a protective casing as a protection element of the assembly in internal and external environments, and which operates in distribution power from ninety to two hundred and fifty Volts at the input of the same connection system point and formed by a power factor rectification and control block (2), a half-bridge block (3) and an ignition pulse block (4), so as to make available a device for control and activation of HO fluorescent lamps (A) with the specific purpose of controlling from one to six lamps, depending directly on the fixture installation needs and exclusively on the sum of power of the HO fluorescent lamps (A), which cannot exceed three hundred and ninety watts.

The power factor rectification and control block (2) rectifies and accommodate the electric energy in order to obtain unit power factor, i.e., the electronic ballast behavior that is of resistive load, which does not imply in charge or consumption of reactive power of the power supply system. The electric energy rectification system is also provided, at its input, with an electronic circuit for the noise reduction of electromagnetic interference (EMI), a requirement for the homologation and guarantee of non-disturbance of the surrounding systems.

The half-bridge block (3), which receives the conditioned energy from the power factor rectification and control block (2), makes available the high frequency energy in square wave form, later converting to alternating wave for the activation and control of energy delivered to the HO fluorescent lamp (A). This half-bridge block (3) is also provided with a protection characteristic that enables the detection of a complete absence of load and still delivers power to the output blocks for a determined period of time only; whereupon the electronic circuits are disconnected from the circuit called half-bridge, thus avoiding unnecessary consumption and any problems caused by human contact in the fixtures. This same circuit attempts, from time to time, to activate the electronic circuits to check the presence of load. A single HO fluorescent lamp (A) is enough for the half-bridge circuit to prevent the output circuits from being disconnected.

The ignition pulse block (4) supplies enough power for the HO fluorescent lamp (A) activation, which are not capable of starting their operation without the presence of the high voltage responsible for the ionization of the gas present in its interior; this block feeds pulses around a thousand and two hundred Volts peak-to-peak that allow the HO fluorescent lamps (A) to start working. As soon as the HO fluorescent lamp (A) receives the activation pulse, the electronic circuit before the ignition pulse block (4) is in charge of the operation and control of the lamp, interrupting the activation pulses thereupon. However, in case one or more HO fluorescent lamps (A) will not start working even after receiving the activation pulse, it still goes on existing until the lamps start working or are replaced. Since this ignition pulse block (4) may cause high voltage shocks in anyone coming in contact with its terminals, there is an incorporated protection system that assures its non-existence with its terminals, there is an incorporated protection system that assures its non-existence in case the HO fluorescent lamp (A) breaks or is removed from the fixture.

The half-bridge block (3) presents a great and significant difference if compared the electronic ballasts known by the current state of the art, since the electronic ballasts described in the present patent uses an activation technology for the output circuits via a full and auto-oscillating bridge circuit.

The concept of the electronic ballast for HO fluorescent lamps is based on an electronic circuit intended for a practical and safe control of a set of HO fluorescent lamps (A) (long size), operating as an electronic controller thereof, capable of operating and controlling from one to six HO fluorescent lamps (A), with a current of eight hundred milliamps in each one, a value that can vary according to the installation needs, and depending exclusively on the sum of power of the lamps, which cannot exceed three hundred and ninety watts. The electronic ballast can use HO fluorescent lamps (A) of any configuration and size, within the specifications mentioned above and, at any moment, its operation is not dependable on the size or the sum of size thereof.

The components of the electronic ballast for HO fluorescent lamps are fully fitted and attached, do not present any parts prone to break or get loose, are highly resistant and completely safe for use. After fitted and attached, the components are locked and attached, thus preventing them from getting loose when in use, and making the assembly fully available for control and activation of HO fluorescent lamps (A) (long size). It can thus be easily used without worries of any nature as for its durability and safety.

For all of the above, this is an invention that will be well received by the users of HO fluorescent lamps (A), since the present electronic ballast for HO fluorescent lamps (A) presents several advantages, such as: great safety, reliability and agility in the processes of activation and control of HO fluorescent lamps (A) since this is a high technology product; great strength and durability, and a low or no wear of the assembly as a whole; greater comfort, facility and safety to he users in general; great efficiency and performance in its application due to its general conception; accessible costs, which provides an optimum cost/benefit ratio; practical and safe use by any users, regardless of the characteristics thereof; great versatility and flexibility provided by the use of a varied number of HO fluorescent lamps (A); practical, safe and reduced general maintenance; and the certainty of always having a fully accurate and reliable product that fully meets the ideal and necessary safety, strength and durability conditions required for its use.

The electronic ballast presents as specific advantage; replacing with full efficiency the current electromagnetic and electronic ballasts for HO fluorescent lamps (A); having full protection against the absence of load, high power factor and high output; enabling its proper operation with a minimum of one and a maximum of six HO fluorescent lamps (A) without any kind of change in the electronic circuit; and fully meeting the electromagnetic interference standards (CISPR 15), thereby providing a piece of equipment fully capable of being used in environments where the generation of any electromagnetic noises is not allowed.

For all of the above, the electronic ballast for HO fluorescent lamps can be classified as a fully efficient, versatile, accurate and safe equipment for control and activation of HO fluorescent lamps (A) in internal and external environments like billboards or large areas in general, such as parking lots, patios and places with high human concentration, regardless of the general characteristics thereof; it is also easy to install, handle and maintain, and have excelled general characteristics; the sizes, dimensions and quantities may vary, depending on the use needs.

What is claimed is:

1. “ELECTRONIC BALLAST FOR HO FLUORESCENT LAMPS” characterized in that it comprises a complete electronic ballast for control and activation of ho fluorescent lamps (a) capable of operating from one to six lamps and in any environment, and incorporating a proprietary structure and containing a properly customized and integrated electronic circuit (1), arranged in a protective casing for internal and external environments, and which operates in distribution power from ninety to two hundred and fifty volts at the input of the same connection voltage point, and being formed by a power factor rectification and control block (2), a half-bridge block (3) and an ignition pulse block (4), the power factor rectification and control block (2) having the power to rectify and accommodate the electric energy to unit power factor and, at its input, an electronic circuit for the noise reduction of the electromagnetic interference (EMI); the half-bridge block (3) receiving the conditioned energy from the power factor rectification and control block (2) and making available high frequency energy (square wave) converted to alternating wave of activation and control of energy, protection against complete absence of load, delivery of power to the output blocks for a determined period of time and checking of the presence or not of load; the ignition pulse block (4) being provided with a power supply for the activation via peak-to-peak pulses and a high voltage shock protection system.
